(19) United States
(12) Patent Application Publication
(10) Pub. No.: US 2026/0173093 A1
(43) Pub. Date: Jun. 18, 2026

(54) METHOD AND APPARATUS FOR PROCESSING CONTINUOUS LISTEN BEFORE TALK FAILURES OF SIDELINK

(71) Applicant: Beijing Xiaomi Mobile Software Co., Ltd., Beijing (CN)

(72) Inventor: Xiaowei JIANG, Beijing (CN)

(73) Assignee: Beijing Xiaomi Mobile Software Co., Ltd., Beijing (CN)

(21) Appl. No.: 19/127,044

(22) PCT Filed: Nov. 3, 2022
(86) PCT No.: PCT/CN2022/129578

§ 371 Date: May 2, 2025

(51) Int. Cl. H04W 72/23; H04W 72/21

(52) U.S. Cl. CPC H04W 72/23; H04W 72/21

(57) ABSTRACT

A method, communication device, and non-transitory computer-readable storage medium for processing sidelink consistent listen before talk (LBT) failure by a terminal device are disclosed. The method includes determining that a sidelink consistent LBT failure has been triggered in a unicast connection, a resource pool, a resource block set (RB set), or a serving cell, and cancelling the state of sidelink consistent LBT failure for the corresponding connection, pool, RB set, or serving cell. The cancellation may be triggered by events such as receipt of a high-layer request to reset media access control (MAC) settings, deactivation of a serving cell, reconfiguration of sidelink consistent LBT parameters, successful transmission of a MAC control element (CE) indicating consistent LBT failure, or receipt of reconfiguration information for mode conversion. The disclosed techniques enhance management and recovery from sidelink consistent LBT failures in unicast and resource-oriented configurations, improving the reliability and flexibility of sidelink communications.

### CROSS REFERENCE

The present application is a national phase application of International Application No. PCT/CN2022/129578, filed on Nov. 3, 2022, and the entire contents thereof are incorporated herein by reference.

### TECHNICAL FIELD

The present disclosure relates to the field of communication technology, and in particular to a method and apparatus for processing a continuous listen-before-speak failure of a sidelink.

### BACKGROUND

In order to support direct communication between terminal devices, the sidelink (SL) communication mode is introduced. When the Sidelink communication uses the unlicensed spectrum, the terminal device needs to perform Listen Before Talk (LBT) when sending Sidelink data on the unlicensed spectrum. The terminal device can detect the number of LBT failures in the sidelink to count the number of consecutive LBT failures in the sidelink.

It should be noted that, information disclosed in the above background portion is provided only for a better understanding of the background of the present disclosure. Thus it may contain information that does not form the prior art known by those ordinary skilled in the art.

### SUMMARY

The present disclosure provides a method and apparatus for processing a continuous listen before talk failure in a sidelink.

A first aspect of the embodiment of the present disclosure provides a method for processing a failure of continuous listen-before-speak in a sidelink, the method being executed by a terminal device and including:
determining a sidelink consistent listen before talk (LBT) failure being triggered in a unicast connection; and
cancelling a state of sidelink consistent LBT failure of the unicast connection.

In some embodiments of the present disclosure, the cancelling the state of sidelink consistent LBT failure of the unicast connection includes:
determining reception of a high-layer request for resetting sidelink media access control of the unicast connection, and cancelling the state of sidelink consistent LBT failure of the unicast connection.

In some embodiments of the present disclosure, the cancelling the state of sidelink consistent LBT failure of the unicast connection includes:
determining reception of a high-layer request for releasing the unicast connection, and cancelling the state of sidelink consistent LBT failure of the unicast connection.

A second aspect of the embodiment of the present disclosure provides a method for processing sidelink consistent listen before talk (LBT) failure, executed by a terminal device and including:
determining a sidelink consistent listen before talk (LBT) failure being triggered in a resource pool; and
cancelling a state of sidelink consistent LBT failure of the resource pool.

In some embodiments of the present disclosure, the cancelling the state of sidelink consistent LBT failure of the resource pool includes:
a serving cell being deactivated, and cancelling the state of sidelink consistent LBT failure of all resource pool on an activated bandwidth part (BWP) of the serving cell.

In some embodiments of the present disclosure, the cancelling the state of sidelink consistent LBT failure of the resource pool includes:
a MAC CE including consistent LBT failure indication information indicating occurrence of the sidelink consistent LBT failure of the resource pool being transmitted successfully, and cancelling the state of sidelink consistent LBT failure of the resource pool.

In some embodiments of the present disclosure, the cancelling the state of sidelink consistent LBT failure of the resource pool includes:
determining sidelink consistent LBT parameter reconfiguration associated with a serving cell, and cancelling the state of sidelink consistent LBT failure of all resource pool on the serving cell.

In some embodiments of the present disclosure, the cancelling the state of sidelink consistent LBT failure of the resource pool includes:
determining sidelink consistent LBT parameter reconfiguration associated with the resource pool, and cancelling the state of sidelink consistent LBT failure of the resource pool.

In some embodiments of the present disclosure, the sidelink consistent LBT parameter at least includes a maximum number of the sidelink consistent LBT failure and a detection timer of the sidelink consistent LBT failure.

A third aspect of the embodiment of the present disclosure provides a method for processing sidelink consistent listen before talk (LBT) failure, executed by a terminal device and including:
determining a sidelink consistent listen before talk (LBT) failure being triggered in a resource block set (RB set); and
cancelling a state of sidelink consistent LBT failure of the RB set.

In some embodiments of the present disclosure, the cancelling the state of sidelink consistent LBT failure of the RB set includes:
a serving cell being deactivated, and cancelling the state of sidelink consistent LBT failure of all RB set on an activated bandwidth part (BWP) of the serving cell.

In some embodiments of the present disclosure, the cancelling the state of sidelink consistent LBT failure of the RB set includes:
when a MAC CE including consistent LBT failure indication information indicating occurrence of the sidelink consistent LBT failure of the RB set being transmitted successfully, cancelling the state of sidelink consistent LBT failure of the RB set.

In some embodiments of the present disclosure, the cancelling the state of sidelink consistent LBT failure of the RB set includes:
determining sidelink consistent LBT parameter reconfiguration associated with a serving cell, and cancelling the state of sidelink consistent LBT failure of all RB set on the serving cell.

In some embodiments of the present disclosure, the cancelling the state of sidelink consistent LBT failure of the RB set includes:
determining sidelink consistent LBT parameter reconfiguration associated with the RB set, and cancelling the state of sidelink consistent LBT failure of the RB set.

In some embodiments of the present disclosure, the sidelink consistent LBT parameter at least includes a maximum number of the sidelink consistent LBT failure and a detection timer of the sidelink consistent LBT failure.

A fourth aspect of the embodiment of the present disclosure provides a method for processing sidelink consistent listen before talk (LBT) failure, executed by a terminal device and including:
determining a sidelink consistent listen before talk (LBT) failure being triggered in a serving cell; and
cancelling a state of sidelink consistent LBT failure of the serving cell.

In some embodiments of the present disclosure, the cancelling the state of sidelink consistent LBT failure of the serving cell includes:
the serving cell being deactivated, and cancelling the state of sidelink consistent LBT failure of the serving cell.

In some embodiments of the present disclosure, the cancelling the state of sidelink consistent LBT failure of the serving cell includes:
a MAC CE including consistent LBT failure indication information indicating occurrence of the sidelink consistent LBT failure of the serving cell being transmitted successfully, and cancelling the state of sidelink consistent LBT failure of the serving cell.

In some embodiments of the present disclosure, the cancelling the state of sidelink consistent LBT failure of the serving cell includes:
determining sidelink consistent LBT parameter reconfiguration associated with the serving cell, and cancelling the state of sidelink consistent LBT failure of the serving cell.

In some embodiments of the present disclosure, the sidelink consistent LBT parameter at least includes a maximum number of the sidelink consistent LBT failure and a detection timer of the sidelink consistent LBT failure.

A fifth aspect of the embodiment of the present disclosure provides a method for processing sidelink consistent listen before talk (LBT) failure, executed by a terminal device and including:
determining a reception of reconfiguration information or configuration information of a mode conversion; and
cancelling, by the terminal device, all/any triggered state of sidelink consistent LBT failure.

In some embodiments of the present disclosure, the cancelling, by the terminal device, all/any triggered state of sidelink consistent LBT failure includes:
cancelling, by the terminal device, the state of sidelink consistent LBT failure of all associated resource pool and/or RB set and/or BWP.

In some embodiments of the present disclosure, the associated resource pool and/or RB set and/or BWP includes at least one of:
all resource pool and/or RB set and/or BWP configured by a network side for the terminal device;
the resource pool and/or RB set and/or BWP used for resource selection and reselection when the terminal device is operated in a resource autonomous selection mode; or
the resource pool and/or RB set and/or BWP on which a resource scheduled by the network device is located when the terminal device is operated in a network dynamic scheduling mode.

A sixth aspect of the embodiment of the present disclosure provides a method for processing sidelink consistent listen before talk (LBT) failure, executed by a terminal device and including:
determining a reception of a higher-layer request for a media access control layer (MAC) reset; and
cancelling, by the terminal device, all/any triggered state of sidelink consistent LBT failure.

In some embodiments of the present disclosure, the cancelling, by the terminal device, all/any triggered state of sidelink consistent LBT failure includes:
cancelling, by the terminal device, the state of sidelink consistent LBT failure of all associated resource pool and/or RB set and/or BWP.

In some embodiments of the present disclosure, the associated resource pool and/or RB set and/or BWP includes at least one of:
all resource pool and/or RB set and/or BWP configured by a network side for the terminal device;
the resource pool and/or RB set and/or BWP used for resource selection and reselection when the terminal device is operated in a resource autonomous selection mode; or
the resource pool and/or RB set and/or BWP on which a resource scheduled by the network device is located when the terminal device is operated in a network dynamic scheduling mode.

A seventh aspect of the embodiment of the present disclosure provides an apparatus for processing sidelink consistent listen before talk (LBT) failure, executed by a terminal device and including:
a processing module, configured to determine a sidelink consistent listen before talk (LBT) failure being triggered in a unicast connection; and
the processing module is further configured to cancel a state of sidelink consistent LBT failure of the unicast connection.

An eighth aspect of the embodiment of the present disclosure provides an apparatus for processing sidelink consistent listen before talk (LBT) failure, executed by a terminal device and including:
a processing module, configured to determine a sidelink consistent listen before talk (LBT) failure being triggered in a resource pool; and
the processing module is further configured to cancel a state of sidelink consistent LBT failure of the resource pool.

A ninth aspect of the embodiment of the present disclosure provides an apparatus for processing sidelink consistent listen before talk (LBT) failure, executed by a terminal device and including:
a processing module, configured to determine a sidelink consistent listen before talk (LBT) failure being triggered in a resource block set (RB set); and
the processing module is further configured to cancel a state of sidelink consistent LBT failure of the RB set.

A tenth aspect of the embodiment of the present disclosure provides an apparatus for processing sidelink consistent listen before talk (LBT) failure, executed by a terminal device and including:
a processing module, configured to determine a sidelink consistent listen before talk (LBT) failure being triggered in a serving cell; and
the processing module is further configured to cancel a state of sidelink consistent LBT failure of the serving cell.

An eleventh aspect of the embodiment of the present disclosure provides an apparatus for processing sidelink consistent listen before talk (LBT) failure, executed by a terminal device and including:
a processing module, configured to determine a reception of reconfiguration information or configuration information of a mode conversion;
the processing module is further configured to cancel, by the terminal device, all/any triggered state of sidelink consistent LBT failure.

A twelfth aspect of the embodiment of the present disclosure provides an apparatus for processing sidelink consistent listen before talk (LBT) failure, executed by a terminal device and including:
a processing module, configured to determine a reception of a higher-layer request for a media access control layer (MAC) reset; and
the processing module is further configured to cancel, by the terminal device, all/any triggered state of sidelink consistent LBT failure.

A thirteenth aspect of the embodiment of the present disclosure provides a communication device, including: a transceiver; a memory; and a processor, connected to the transceiver and the memory respectively, configured to control wireless signal reception and transmission of the transceiver by executing computer executable instructions on the memory, and capable of implementing the method according to the first aspect of the embodiment of the present disclosure or the second aspect of the embodiment of the present disclosure or the third aspect of the embodiment of the present disclosure or the fourth aspect of the embodiment of the present disclosure or the fifth aspect of the embodiment of the present disclosure or the sixth aspect of the embodiment of the present disclosure.

A fourteenth aspect of the embodiment of the present disclosure provides an computer storage medium, wherein the computer storage medium stores computer executable instructions; after the computer executable instructions being executed by a processor, the method according to the first aspect of the embodiment of the present disclosure or the second aspect of the embodiment of the present disclosure or the third aspect of the embodiment of the present disclosure or the fourth aspect of the embodiment of the present disclosure or the fifth aspect of the embodiment of the present disclosure or the sixth aspect of the embodiment of the present disclosure can be implemented.

Additional aspects and advantages of the present disclosure will be given in part in the following description and in part will be obvious from the following description or learned through practice of the present disclosure.

It is to be understood that both the foregoing general description and the following detailed description are exemplary and explanatory only and are not restrictive of the present disclosure.

### BRIEF DESCRIPTION OF THE DRAWINGS

The above and/or additional aspects and advantages of the present disclosure will become apparent and easily understood from the following description of the embodiments in conjunction with the accompanying drawings, in which:

FIG. 1 is a flow chart of a method for processing sidelink consistent listen before talk failure according to an embodiment of the present disclosure;

FIG. 2 is a flow chart of a method for processing sidelink consistent listen before talk failure according to an embodiment of the present disclosure;

FIG. 3 is a flow chart of a method for processing sidelink consistent listen before talk failure according to an embodiment of the present disclosure;

FIG. 4 is a flow chart of a method for processing sidelink consistent listen before talk failure according to an embodiment of the present disclosure;

FIG. 5 is a flow chart of a method for processing sidelink consistent listen before talk failure according to an embodiment of the present disclosure;

FIG. 6 is a flow chart of a method for processing sidelink consistent listen before talk failure according to an embodiment of the present disclosure;

FIG. 7 is a block diagram of an apparatus for processing sidelink consistent listen before talk failure according to an embodiment of the present disclosure;

FIG. 8 is a block diagram of an apparatus for processing sidelink consistent listen before talk failure according to an embodiment of the present disclosure;

FIG. 9 is a block diagram of an apparatus for processing sidelink consistent listen before talk failure according to an embodiment of the present disclosure;

FIG. 10 is a block diagram of an apparatus for processing sidelink consistent listen before talk failure according to an embodiment of the present disclosure;

FIG. 11 is a block diagram of an apparatus for processing sidelink consistent listen before talk failure according to an embodiment of the present disclosure;

FIG. 12 is a block diagram of an apparatus for processing sidelink consistent listen before talk failure according to an embodiment of the present disclosure;

FIG. 13 is a schematic diagram of the structure of a communication device according to an embodiment of the present disclosure; and

FIG. 14 is a schematic diagram of the structure of a chip provided in an embodiment of the present disclosure.

### DETAILED DESCRIPTION

Embodiments of the present disclosure are described in detail below, and examples of the embodiments are shown in the accompanying drawings, wherein the same or similar reference numerals throughout represent the same or similar elements or elements having the same or similar functions. The embodiments described below with reference to the accompanying drawings are exemplary and are intended to be used to explain the present disclosure, and should not be construed as limiting the present disclosure.

Embodiments of the present application are described in detail below, and examples of the embodiments are shown in the accompanying drawings, wherein the same or similar reference numerals throughout represent the same or similar elements or elements having the same or similar functions. The embodiments described below with reference to the accompanying drawings are exemplary and are intended to be used to explain the present application, and should not be construed as limitations on the present application. It should be noted that, without conflict, the embodiments of the present application and the features in the embodiments may be combined with each other without conflict.

The terms used in the embodiments of the present application are only for the purpose of describing specific embodiments, and are not intended to limit the embodiments of the present application. The singular forms of “a” and “the” used in the embodiments of the present application and the appended claims are also intended to include plural forms, unless the context clearly indicates other meanings. It should also be understood that the term “and/or” used herein refers to and includes any or all possible combinations of one or more associated listed items.

It should be understood that, although the terms first, second, third, etc. may be used to describe various information in the embodiments of the present application, the information should not be limited to these terms. These terms are only used to distinguish the same type of information from each other. For example, without departing from the scope of the embodiments of the present application, the first information may also be referred to as the second information, and similarly, the second information may also be referred to as the first information. Depending on the context, the word “if” as used herein may be interpreted as “at the time of” or “when” or “in response to determination”.

To facilitate understanding, the terms involved in this embodiment are introduced first.

### 1. Sidelink (SL)

The communication interface between the terminal device (User Equipment, UE) and the terminal device is called the PC-5 interface. On the PC-5 interface, the link for transmitting data between the terminal device and the terminal device is called the sidelink. According to the corresponding relationship between the transmitting UE and the receiving UE, three transmission modes can be supported on the sidelink, including: unicast, multicast and broadcast. The transmitting UE sends the sidelink control information (SCI) on the physical sidelink control channel (PSCCH) and sends the second stage SCI on the physical sidelink shared channel (PSSCH), which carries the resource location of the transmission data and the source and destination identifiers. For the data packets enabled with hybrid automatic repeat request (HARQ) feedback, the receiving UE performs HARQ-ACK feedback to the PSSCH on the physical sidelink feedback channel (PSFCH).

### 2. Listen Before Talk (LBT)

LBT is a technology to avoid channel access conflicts. Different terminal devices compete for shared unlicensed (or license-free) spectrum resources through LBT operations. Communication protocol version 18 (release18, R18) supports sidelink communication using unlicensed spectrum. Terminal devices also need to perform LBT when sending sidelink data on unlicensed spectrum. The consistent LBT mechanism is also applicable to sidelink communication on unlicensed spectrum.

### 3. Physical Sidelink Control Channel (PSCCH)

PSCCH is a physical sidelink control channel, which includes sidelink control signaling. This physical channel indicates PSSCH channel resources and transmission parameters.

### 4. Physical Sidelink Shared Channel (PSSCH)

PSSCH is the physical sidelink shared channel, which carries the data of sidelink communication.

### 5. Physical Sidelink Feedback Channel (PSFCH)

PSFCH is used to carry HARQ feedback information on the sidelink.

### 6. 5G Radio Interface Operating in Unlicensed Spectrum (5G NewRadio in Unlicensed Spectrum, 5G NR-U)

NR-U is a project of the 3rd Generation Partnership Project (3GPP) in R16, which provides the necessary technology for operators to fully integrate unlicensed spectrum into 5G networks. NR-U supports uplink and downlink operations in unlicensed frequency bands. In NR-U, channel access for both downlink and uplink relies on the listen before talk (LBT) feature. The wireless device or base station must first “sense” the communication channel and find that there is no communication before any transmission. When a communication channel is an unlicensed wideband carrier (for example, hundreds of megahertz), the LBT process relies on detecting energy levels on multiple sub-bands of the communication channel. LBT parameters (such as type/duration, clear channel assessment parameters, etc.) are configured on the wireless device by the base station.

In the disclosure, consistent LBT failure is a new feature defined in NR-U. The UE counts the number of uplink LBT failures on each bandwidth (Bandwidth Part, BWP). The network side configures the maximum number of consistent LBT failures (lbt-FailureInstanceMaxCount) and the consistent LBT failure detection timer (lbt-FailureDetection Timer) for each serving cell through Radio Resource Control (RRC) signaling to count consistent LBT failures. The UE maintains an LBT counter variable for each cell, and the initial value of the variable is 0. For each activated cell configured with lbt-FailureRecoveryConfig, when the UE receives the LBT failure indication submitted by the physical layer, it starts or restarts the lbt-FailureDetection Timer, and the LBT counter is increased by 1. When the LBT_counter is greater than or equal to the lbt-FailureInstanceMaxCount, a consistent LBT failure is triggered on the activated BWP on the cell. When lbt-FailureDetectionTimer is expired or the higher layer reconfigures lbt-FailureInstanceMaxCount/lbt-FailureDetectionTimer or all consecutive LBT failures on this serving cell are cancelled, the UE resets the LBT counter to 0. When the terminal detects consecutive LBT failures on the activated BWP of the primary cell (PCell) or the primary secondary cell (PSCell), if there are other BWPs configured with physical random access channel (PRACH) resources on the cell, the terminal triggers BWP switch, switches to the BWP configured with PRACH resources and initiates the random access channel (RACH) process. If the UE detects consecutive LBT failures on N BWPs configured with PRACH resources in the primary cell, the UE initiates the Radio Link Failure (RLF) recovery process. If consistent LBT failure is detected on the activated BWP of the SCell (secondary cell), the UE indicates the cell identity of the consistent LBT failure to the network side through MAC CE. The MAC CE can carry multiple cell identities of the consistent LBT failure detected. The MAC CE is sent through other serving cells where no consistent LBT failure occurs. If the MAC PDU containing the consistent LBT failure MAC CE is sent successfully, the UE will cancel the consistent LBT failure status of the cell where the consistent LBT failure occurs, which is indicated by the consistent LBT failure MAC CE. If consistent LBT failure is triggered on the PCell (primary cell) or PSCell, and the RACH process is successfully completed, the UE cancels the consistent LBT failure status of the PCell (primary cell) or PSCell. If the UE receives a physical downlink control channel (PDCCH) indicating the BWP switching of a certain serving cell, the consistent LBT failure status of this cell is canceled.

R18 supports Sidelink communication using unlicensed spectrum. Terminal devices also need to perform LBT when sending Sidelink data on unlicensed spectrum. The consistent LBT mechanism also applies to Sidelink communication on unlicensed spectrum. However, it is currently unclear when to cancel the consistent LBT failure state in the Sidelink-U scenario.

To this end, this embodiment proposes a method and apparatus for processing the failure of consistent listen before talk in the sidelink, which allows the terminal device to cancel the failure state of consistent listen before talk in the sidelink according to the corresponding node, when determining the sidelink consistent listen before talk (LBT) failure being triggered, under different detection granularities when the sidelink is operated in the unlicensed spectrum (Sidelink-U) scenario.

It is understandable that the solution provided by the present disclosure can be applied to terminal devices or other executable subjects. In the following embodiments of the present disclosure, the technical solution in the present disclosure is described by taking the execution subject as a terminal device as an example, but it does not constitute a specific limitation. In the disclosure, the terminal device can be a communication device such as a mobile phone, a notebook, a tablet computer, a POS machine, and a vehicle on board computer, etc., which is not limited in the present disclosure.

Hereinafter, the method and apparatus for processing sidelink consistent listen before talk (LBT) failure provided by the present application is introduced in detail in conjunction with the accompanying drawings.

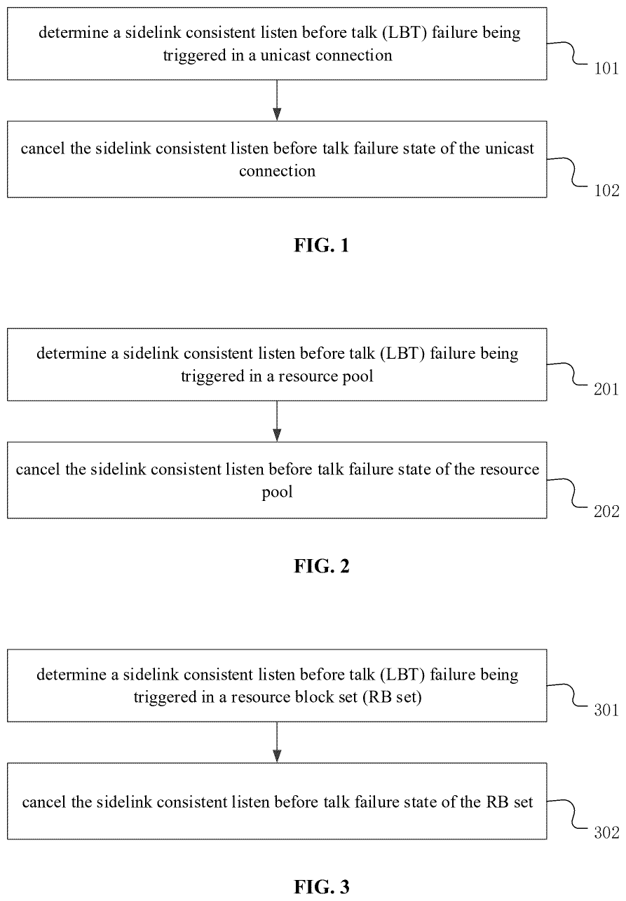

FIG. 1 shows a schematic flow chart of a method for processing sidelink consistent listen before talk failure according to an embodiment of the present disclosure. As shown in FIG. 1, the method is applied to a terminal device, and the embodiment may include the following steps.
Step 101: determine a sidelink consistent listen before talk (LBT) failure being triggered in a unicast connection.

For the embodiments of the present disclosure, the detection granularity of the sidelink consistent LBT failure may be the granularity of the source address and the target address pair. In a specific application scenario, the terminal device may count the number of consistent LBT failures of the sidelink of the unicast connection at this detection granularity, wherein, exemplarily, the unicast connection may correspond to PC5-RRC, and the network device configures the corresponding maximum number of consistent LBT failures of the sidelink and the consistent LBT failure detection timer of the sidelink to the terminal device through the radio resource control (RRC) signaling, wherein the maximum number of consistent LBT failures of the sidelink and the consistent LBT failure detection timer of the sidelink are used to count the consistent LBT failures of the sidelink. If within the specified time, the number of consistent LBT failures of the sidelink of the unicast connection currently counted is greater than or equal to the maximum number, it can be considered that the sidelink consistent LBT failure has been triggered in the unicast connection.
Step 102: cancel the sidelink consistent listen before talk failure state of the unicast connection.

As a possible implementation method, the detection granularity of the sidelink consistent LBT failure can be the granularity of the source address and the destination address pair. When the media access control layer (MAC) layer of the terminal device receives the SL MAC reset request of the high layer for the unicast connection associated with the source address and the destination address pair, the terminal device cancels the consistent listen before talk failure state of the sidelink associated with this unicast connection. Accordingly, step 102 of the embodiment may specifically include: determining that a high layer request for a sidelink media access control reset of a unicast connection is received, and canceling the consistent LBT failure state of the sidelink of the unicast connection. In actual applications, the high layer may be a vehicle to everything (V2X) layer, etc.

For example, it is determined that the failure of sidelink consistent listen before talk (LBT) is triggered in the unicast connection A, and when the MAC layer receives a high-layer request from the high-level layer to reset the sidelink media access control of the unicast connection A, the terminal device can cancel the sidelink consistent LBT failure status of the unicast connection A.

As a possible implementation, the detection granularity of the sidelink consistent LBT failure is the granularity of the source address and the destination address pair. When the higher layer requests to release the unicast connection, the terminal device cancels the sidelink consistent LBT failure state associated with the unicast connection. Accordingly, step 102 of the embodiment may specifically include: determining that a higher layer request to release the unicast connection is received, and canceling the sidelink consistent LBT failure state of the unicast connection.

For example, it is determined that the failure of the sidelink consistent listen before talk (LBT) is triggered in the unicast connection B, and when the MAC layer receives the high-layer request from the high-layer to release the unicast connection B, the terminal device can cancel the sidelink consistent LBT failure status of the unicast connection B.

In summary, according to the method for processing sidelink consistent listen before talk failure provided by the embodiment of the present disclosure, the terminal device can respond to the high-layer request to cancel the sidelink consistent listen before talk failure state of the unicast connection when determining that the sidelink consistent listen before talk LBT failure is triggered in the unicast connection, thereby ensuring the effective transmission of the sidelink data of the unicast connection on the unlicensed spectrum.

FIG. 2 shows a schematic flow chart of a method for processing sidelink consistent listen before talk failure according to an embodiment of the present disclosure. As shown in FIG. 2, the method is applied to a terminal device, and the embodiment may include the following steps.
Step 201: determine a sidelink consistent listen before talk (LBT) failure being triggered in a resource pool.

For the embodiment of the present disclosure, the detection granularity of the sidelink consistent LBT failure can be the resource pool granularity. If the consistent LBT failure is triggered at the resource pool granularity, then the LBT failure on any resource in a resource pool is counted as the LBT failure of the resource pool. If the condition of consistent LBT failure is met, the terminal device considers that the consistent LBT failure is triggered in the resource pool. In a specific application scenario, the number of sidelink LBT failures is counted for the PSSCH and/or PSCCH and/or PSFCH transmissions sent by the resources in the resource pool currently used by the terminal device, and the network device configures the corresponding maximum number of consistent LBT failures of the sidelink and the consistent LBT failure detection timer of the sidelink to the terminal device through RRC signaling, wherein the maximum number of consistent LBT failures of the sidelink and the consistent LBT failure detection timer of the sidelink are used to count the consistent LBT failures of the sidelink. If the number of sidelink LBT failures of the currently used resource pool is greater than or equal to the maximum number within the specified time, it can be considered that the sidelink consistent LBT failure has been triggered in the currently used resource pool.
Step 202: cancel the sidelink consistent listen before talk failure state of the resource pool.

As a possible implementation method, the detection granularity of the sidelink consistent LBT failure may be the granularity of the resource pool. When the consistent listen before talk (LBT) failure of the sidelink is triggered in the resource pool, in response to the deactivation of the serving cell, the terminal device may cancel the consistent listen before talk failure state of the sidelink of all resource pools on the corresponding activation bandwidth (Bandwidth Part, BWP) of this serving cell (cancel the SL consistent LBT failure state of all resource pools in which the SL consistent LBT failure is triggered). Accordingly, step 202 of the embodiment may specifically include: deactivating the serving cell, cancelling the consistent LBT failure state of the sidelink of all resource pools on the activation bandwidth BWP of the serving cell (cancel the SL consistent LBT failure state of all resource pools in which the SL consistent LBT failure is triggered).

For example, if a sidelink consistent LBT failure is triggered in a resource pool, when serving cell a is deactivated, the sidelink consistent listen before talk failure status of all resource pools on the activated bandwidth BWP corresponding to the serving cell a can be canceled (the SL consistent LBT failure status of all resource pools in which the SL consistent LBT failure is triggered can be canceled).

As a possible implementation, the detection granularity of the sidelink consistent LBT failure can be the resource pool granularity. When the sidelink consistent listen before talk (LBT) failure is triggered in the current resource pool, if the MAC protocol data unit (PDU) containing the SL consistent LBT failure media access control (MAC) control element (CE) is sent successfully, and the SL consistent LBT failure MAC CE contains the SL consistent LBT failure indication of this resource pool, the sidelink consistent LBT failure state of this resource pool is canceled. When it is determined that the sidelink consistent listen before talk (LBT) failure is triggered in the resource pool, the terminal will indicate the indication information of the current resource pool where the consistent LBT failure occurs to the network side through the MAC CE. If the MAC PDU containing the consistent LBT failure MAC CE is sent successfully, the terminal device cancels the sidelink consistent LBT failure state of the current resource pool. Correspondingly, step 202 of the embodiment may specifically include: the MAC CE containing the consistent LBT failure indication information of the sidelink consistent LBT failure of the resource pool being sent successfully, and cancelling the sidelink consistent LBT failure state of the resource pool.

For example, if a sidelink consistent LBT failure is triggered in the currently used resource pool A and the reporting of the SL consistent LBT failure MAC CE is triggered, the SL consistent LBT failure MAC CE includes the consistent LBT failure indication information of resource pool A. When the terminal device determines that the SL consistent LBT failure MAC CE is sent successfully, the terminal device cancels the sidelink consistent LBT failure status of resource pool A. The successful sending means that the SL consistent LBT failure MAC CE is included in the new transmission of the MAC PDU of the terminal device, which means that the terminal device receives a new transmission authorization, and determines through the logical channel priority process that the SL consistent LBT failure MAC CE and the sub-header of the SL consistent LBT failure MAC CE can be included in the new transmission of MAC PDU.

As a possible implementation method, if the SL consistent LBT parameter is configured in each serving cell, the detection granularity of the sidelink consistent LBT failure may be the resource pool granularity. When the SL consistent LBT parameter associated with the serving cell is reconfigured, the sidelink consistent LBT failure status of all resource pools on the reconfigured serving cell is canceled (cancelling the SL consistent LBT failure status of all resource pools in which the SL consistent LBT failure is triggered). Accordingly, step 202 of the embodiment may specifically include: determining the reconfiguration of the sidelink consistent LBT parameter associated with the serving cell, and canceling the sidelink consistent LBT failure status of all resource pools on the serving cell (cancelling the SL consistent LBT failure status of all resource pools in which the SL consistent LBT failure is triggered). In the disclosure, the sidelink consistent LBT parameter includes the maximum number of sidelink consistent LBT failures and/or the sidelink consistent LBT failure detection timer, and the maximum number of sidelink consistent LBT failures and/or the sidelink consistent LBT failure detection timer are used to count the sidelink consistent LBT failures. The sidelink consistent LBT parameters may include some other newly defined sidelink consistent LBT parameters, which are not limited in this embodiment.

For example, if the SL consistent LBT parameters are configured in each serving cell, if the sidelink consistent LBT failure is triggered in the resource pool, when the sidelink consistent LBT parameters associated with the serving cell b (the maximum number of sidelink consistent LBT failures and/or the sidelink consistent LBT failure detection timer and/or other newly defined sidelink consistent LBT parameters) are reconfigured, the terminal device cancels the sidelink consistent LBT failure status of all resource pools on this serving cell b (cancels the SL consistent LBT failure status of all resource pools in which the SL consistent LBT failure is triggered).

As a possible implementation, if the SL consistent LBT parameter is configured in each resource pool, the detection granularity of the sidelink consistent LBT failure may be the resource pool granularity, and when the SL consistent LBT parameter associated with the resource pool is reconfigured, if the SL consistent LBT failure is triggered in the resource pool, the sidelink consistent LBT failure state of the reconfigured resource pool is canceled. Accordingly, step 202 of the embodiment may specifically include: determining the reconfiguration of the sidelink consistent LBT parameter associated with the resource pool, and if the SL consistent LBT failure is triggered in the resource pool, canceling the sidelink consistent LBT failure state of the resource pool. In the present disclosure, the sidelink consistent LBT parameter includes the maximum number of sidelink consistent LBT failures and/or the sidelink consistent LBT failure detection timer, and the maximum number of sidelink consistent LBT failures and/or the sidelink consistent LBT failure detection timer are used to count the sidelink consistent LBT failures. The sidelink consistent LBT parameter may include some other newly defined sidelink consistent LBT parameters, which are not limited in this embodiment.

For example, if SL consistent LBT parameters are configured in each resource pool, if a sidelink consistent LBT failure is triggered in resource pool C, when the sidelink consistent LBT parameters associated with resource pool C (the maximum number of sidelink consistent LBT failures and/or the sidelink consistent LBT failure detection timer and/or other newly defined sidelink consistent LBT parameters) are reconfigured, the terminal device cancels the sidelink consistent LBT failure status of this resource pool C.

In summary, according to the method for processing sidelink consistent listen before talk failure provided by the embodiment of the present disclosure, the terminal device can, when it is determined that the sidelink consistent listen before talk (LBT) failure is triggered in the resource pool currently in use, cancel the consistent listen before talk failure status of the sidelink in the resource pool at the node when the serving cell is deactivated, or the MAC CE containing the consistent LBT failure indication information of the consistent LBT failure in the resource pool is sent successfully, or the sidelink consistent LBT parameters associated with the serving cell are reconfigured, or the sidelink consistent LBT parameters associated with the resource pool are reconfigured, thereby ensuring the effective transmission of the sidelink data in the resource pool in the unlicensed spectrum.

FIG. 3 shows a schematic flow chart of a method for processing sidelink consistent listen before talk failure according to an embodiment of the present disclosure. As shown in FIG. 3, the method is applied to a terminal device, and the embodiment may include the following steps.
Step 301: determine a sidelink consistent listen before talk (LBT) failure being triggered in a resource block set (RB set).

For the embodiment of the present disclosure, the detection granularity of the sidelink consistent LBT failure can be the resource block set (RB set) granularity. If the consistent LBT failure is triggered at the RB set granularity, then the LBT failure on any resource in a RB set is counted as the LBT failure of the RB set. If the condition of consistent LBT failure is met, the terminal device considers that the consistent LBT failure is triggered in the RB set. In a specific application scenario, the number of sidelink LBT failures is counted for the PSSCH and/or PSCCH and/or PSFCH transmissions sent by the resources in the RB set currently used by the terminal device, and the network device configures the corresponding maximum number of consistent LBT failures of the sidelink and the consistent LBT failure detection timer of the sidelink to the terminal device through RRC signaling, wherein the maximum number of consistent LBT failures of the sidelink and the consistent LBT failure detection timer of the sidelink are used to count the consistent LBT failures of the sidelink. If the number of sidelink LBT failures of the currently used RB set is greater than or equal to the maximum number within the specified time, it can be considered that the sidelink consistent LBT failure has been triggered in the currently used RB set.
Step 302: cancel the sidelink consistent listen before talk failure state of the RB set.

As a possible implementation method, the detection granularity of the sidelink consistent LBT failure may be the granularity of the RB set. When the consistent listen before talk (LBT) failure of the sidelink is triggered in the RB set, in response to the deactivation of the serving cell, the terminal device may cancel the consistent listen before talk failure state of the sidelink of all RB sets on the corresponding activation bandwidth (Bandwidth Part, BWP) of this serving cell (cancel the SL consistent LBT failure state of all RB sets in which the SL consistent LBT failure is triggered). Accordingly, step 302 of the embodiment may specifically include: deactivating the serving cell, cancelling the consistent LBT failure state of the sidelink of all RB sets on the activation bandwidth BWP of the serving cell (cancel the SL consistent LBT failure state of all RB sets in which the SL consistent LBT failure is triggered).

For example, if a sidelink consistent LBT failure is triggered in a RB set, when serving cell a is deactivated, the sidelink consistent listen before talk failure status of all RB sets on the activated bandwidth BWP corresponding to the serving cell a can be canceled (the SL consistent LBT failure status of all RB sets in which the SL consistent LBT failure is triggered can be canceled).

As a possible implementation, the detection granularity of the sidelink consistent LBT failure can be the RB set granularity. When the sidelink consistent listen before talk (LBT) failure is triggered in the RB set, and the MAC PDU containing the SL consistent LBT failure MAC CE being sent successfully, and the SL consistent LBT failure MAC CE contains the SL consistent LBT failure indication of this RB set, the sidelink consistent LBT failure state of this RB set is canceled. When it is determined that the sidelink consistent listen before talk (LBT) failure is triggered in the RB set, the terminal will indicate the indication information of the current RB set where the consistent LBT failure occurs to the network side through the MAC CE. If the MAC PDU containing the consistent LBT failure MAC CE is sent successfully, the terminal device cancels the sidelink consistent LBT failure state of the current RB set. Correspondingly, step 302 of the embodiment may specifically include: when the MAC CE containing the consistent LBT failure indication information of the sidelink consistent LBT failure of the RB set is sent successfully, cancelling the sidelink consistent LBT failure state of the RB set.

For example, if a sidelink consistent LBT failure is triggered in the currently used RB set A and the reporting of the SL consistent LBT failure MAC CE is triggered, the SL consistent LBT failure MAC CE includes the consistent LBT failure indication information of RB set A. When the terminal device determines that the SL consistent LBT failure MAC CE is sent successfully, the terminal device cancels the sidelink consistent LBT failure status of RB set A. The successful sending means that the SL consistent LBT failure MAC CE is included in the new transmission of the MAC PDU of the terminal device, which means that the terminal device receives a new transmission authorization, and determines through the logical channel priority process that the SL consistent LBT failure MAC CE and the sub-header of the SL consistent LBT failure MAC CE can be included in the new transmission of MAC PDU.

As a possible implementation method, if the SL consistent LBT parameter is configured in each serving cell, the detection granularity of the sidelink consistent LBT failure may be the RB set granularity. When the SL consistent LBT parameter associated with the serving cell is reconfigured, the sidelink consistent LBT failure status of all RB sets on all corresponding resource pools of the reconfigured serving cell is canceled (cancelling the SL consistent LBT failure status of all RB sets in which the SL consistent LBT failure is triggered). Accordingly, step 302 of the embodiment may specifically include: determining the reconfiguration of the sidelink consistent LBT parameter associated with the serving cell, and canceling the sidelink consistent LBT failure status of all RB sets on the serving cell (cancelling the SL consistent LBT failure status of all RB sets in which the SL consistent LBT failure is triggered). In the disclosure, the sidelink consistent LBT parameter includes the maximum number of sidelink consistent LBT failures and/or the sidelink consistent LBT failure detection timer, and the maximum number of sidelink consistent LBT failures and/or the sidelink consistent LBT failure detection timer are used to count the sidelink consistent LBT failures. The sidelink consistent LBT parameters may include some other newly defined sidelink consistent LBT parameters, which are not limited in this embodiment.

For example, if the SL consistent LBT parameters are configured in each serving cell, if the sidelink consistent LBT failure is triggered in the RB set, when the sidelink consistent LBT parameters associated with the serving cell b (the maximum number of sidelink consistent LBT failures and/or the sidelink consistent LBT failure detection timer and/or other newly defined sidelink consistent LBT parameters) are reconfigured, the terminal device cancels the sidelink consistent LBT failure status of all RB sets on this serving cell b (cancels the SL consistent LBT failure status of all RB sets in which the SL consistent LBT failure is triggered).

As a possible implementation, if the SL consistent LBT parameter is configured in each RB set, the detection granularity of the sidelink consistent LBT failure may be the RB set granularity, and when the SL consistent LBT parameter associated with the RB set is reconfigured, if the SL consistent LBT failure is triggered in the RB set, the sidelink consistent LBT failure state of the reconfigured RB set is canceled. Accordingly, step 302 of the embodiment may specifically include: determining the reconfiguration of the sidelink consistent LBT parameter associated with the RB set, and if the SL consistent LBT failure is triggered in the RB set, canceling the sidelink consistent LBT failure state of the RB set. In the present disclosure, the sidelink consistent LBT parameter includes the maximum number of sidelink consistent LBT failures and/or the sidelink consistent LBT failure detection timer, and the maximum number of sidelink consistent LBT failures and/or the sidelink consistent LBT failure detection timer are used to count the sidelink consistent LBT failures. The sidelink consistent LBT parameter may include some other newly defined sidelink consistent LBT parameters, which are not limited in this embodiment.

For example, if SL consistent LBT parameters are configured in each RB set, if a sidelink consistent LBT failure is triggered in RB set C, when the sidelink consistent LBT parameters associated with RB set C (the maximum number of sidelink consistent LBT failures and/or the sidelink consistent LBT failure detection timer and/or other newly defined sidelink consistent LBT parameters) are reconfigured, the terminal device cancels the sidelink consistent LBT failure status of this RB set C.

In summary, according to the method for processing sidelink consistent listen before talk failure provided by the embodiment of the present disclosure, the terminal device can, when it is determined that the sidelink consistent listen before talk (LBT) failure is triggered in the RB set currently in use, cancel the consistent listen before talk failure status of the sidelink in the RB set when the serving cell is deactivated, or the MAC CE containing the consistent LBT failure indication information of the consistent LBT failure in the RB set is sent successfully, or the sidelink consistent LBT parameters associated with the serving cell are reconfigured, or when the sidelink consistent LBT parameters associated with the RB set are reconfigured, thereby ensuring the effective transmission of the sidelink data in the RB set in the unlicensed spectrum.

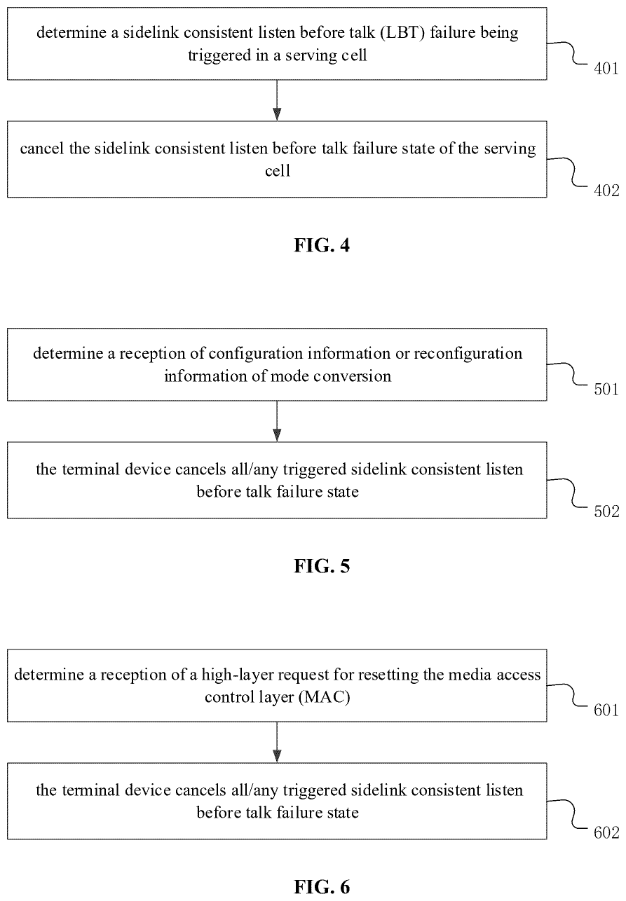

FIG. 4 shows a schematic flow chart of a method for processing sidelink consistent listen before talk failure according to an embodiment of the present disclosure. As shown in FIG. 4, the method is applied to a terminal device, and the embodiment may include the following steps.
Step 401: determine a sidelink consistent listen before talk (LBT) failure being triggered in a serving cell.

At present, only one activated bandwidth is supported on a serving cell. For the embodiment of the present disclosure, as a possible implementation, the detection granularity of the sidelink consistent LBT failure can be the granularity of the BWP activated in the serving cell. In a specific application scenario, the number of sidelink LBT failures is counted for the activated BWP currently used by the terminal device, that is, the number of sidelink LBT transmission failures is counted for the PSSCH and/or PSCCH and/or PSFCH transmissions sent by the resources in all the activated BWP currently used. The network device configures the corresponding maximum number of consistent LBT failures of the sidelink and the consistent LBT failure detection timer of the sidelink to the terminal device through RRC signaling, wherein the maximum number of consistent LBT failures of the sidelink and the consistent LBT failure detection timer of the sidelink are used to count the consistent LBT failures of the sidelink. If the number of sidelink LBT failures of the currently used activated BWP is greater than or equal to the maximum number within the specified time, it can be considered that the sidelink consistent LBT failure has been triggered in the currently used serving cell.

For the embodiments of the present disclosure, as a possible implementation method, the detection granularity of the sidelink consistent LBT failure may be the granularity of the serving cell. In a specific application scenario, the number of sidelink LBT failures is counted for the serving cell currently used by the terminal device. That is, the number of sidelink LBT failures is counted for the PSSCH and/or PSCCH and/or PSFCH transmissions sent by all resources on the currently used cell. The network device configures the corresponding maximum number of consistent LBT failures of the sidelink and the consistent LBT failure detection timer of the sidelink to the terminal device through RRC signaling, wherein the maximum number of consistent LBT failures of the sidelink and the consistent LBT failure detection timer of the sidelink are used to count the consistent LBT failures of the sidelink. If the number of sidelink LBT failures of the currently used serving cell is greater than or equal to the maximum number within the specified time, it can be considered that the sidelink consistent LBT failure is triggered in the currently used serving cell.
Step 402: cancel the sidelink consistent listen before talk failure state of the serving cell.

As a possible implementation method, the detection granularity of the sidelink consistent LBT failure may be the granularity of the BWP or the serving cell. When the consistent listen before talk (LBT) failure of the sidelink is triggered in the BWP or the serving cell, in response to the deactivation of the serving cell, the terminal device may cancel the consistent listen before talk failure state of the sidelink of this serving cell (cancel the SL consistent LBT failure state of the serving cell in which the SL consistent LBT failure is triggered). Accordingly, step 402 of the embodiment may specifically include: deactivating the serving cell, cancelling the consistent LBT failure state of the sidelink of the serving cell (cancel the SL consistent LBT failure state of the serving cell in which the SL consistent LBT failure is triggered).

For example, if a sidelink consistent LBT failure is triggered in an activated BWP in a serving cell A or in the serving cell A, when serving cell Ais deactivated, the sidelink consistent listen before talk failure status of the serving cell A can be canceled (the SL consistent LBT failure status of the serving cell in which the SL consistent LBT failure is triggered can be canceled).

As a possible implementation, the detection granularity of the sidelink consistent LBT failure can be the BWP granularity or the serving cell granularity. When the sidelink consistent listen before talk (LBT) failure is triggered in the BWP or the serving cell, and the MAC PDU containing the SL consistent LBT failure MAC CE being sent successfully, and the SL consistent LBT failure MAC CE contains the SL consistent LBT failure indication of this serving cell, the sidelink consistent LBT failure state of this serving cell is canceled. When it is determined that the sidelink consistent listen before talk (LBT) failure is triggered in the BWP or the serving cell, the terminal will indicate the indication information of the current serving cell where the consistent LBT failure occurs to the network side through the MAC CE. If the MAC PDU containing the consistent LBT failure MAC CE is sent successfully, the terminal device cancels the sidelink consistent LBT failure state of the current serving cell. Correspondingly, step 402 of the embodiment may specifically include: the MAC CE containing the consistent LBT failure indication information of the sidelink consistent LBT failure of the serving cell being sent successfully, and cancelling the sidelink consistent LBT failure state of the serving cell.

For example, if a sidelink consistent LBT failure is triggered in the currently used BWP or serving cell A and the reporting of the SL consistent LBT failure MAC CE is triggered, the SL consistent LBT failure MAC CE includes the consistent LBT failure indication information of serving cell A. When the terminal device determines that the SL consistent LBT failure MAC CE is sent successfully, the terminal device cancels the sidelink consistent LBT failure status of serving cell A. The successful sending means that the SL consistent LBT failure MAC CE is included in the new transmission of the MAC PDU of the terminal device, which means that the terminal device receives a new transmission authorization, and determines through the logical channel priority process that the SL consistent LBT failure MAC CE and the sub-header of the SL consistent LBT failure MAC CE can be included in the new transmission of MAC PDU.

As a possible implementation method, if the SL consistent LBT parameter is configured in each serving cell, the detection granularity of the sidelink consistent LBT failure may be the BWP granularity or the serving cell granularity. When the SL consistent LBT parameter associated with the serving cell is reconfigured, the sidelink consistent LBT failure status of the reconfigured serving cell is canceled. Accordingly, step 402 of the embodiment may specifically include: determining the reconfiguration of the sidelink consistent LBT parameter associated with the serving cell, and canceling the sidelink consistent LBT failure status of the serving cell. In the disclosure, the sidelink consistent LBT parameter includes the maximum number of sidelink consistent LBT failures and/or the sidelink consistent LBT failure detection timer, and the maximum number of sidelink consistent LBT failures and/or the sidelink consistent LBT failure detection timer are used to count the sidelink consistent LBT failures. The sidelink consistent LBT parameters may include some other newly defined sidelink consistent LBT parameters, which are not limited in this embodiment.

For example, if the SL consistent LBT parameters are configured in each serving cell, if the sidelink consistent listen before talk (LBT) failure is triggered in the BWP or the serving cell B, when the sidelink consistent LBT parameters associated with the serving cell B (the maximum number of sidelink consistent LBT failures and/or the sidelink consistent LBT failure detection timer and/or other newly defined sidelink consistent LBT parameters) are reconfigured, the terminal device cancels the sidelink consistent LBT failure status of this serving cell B.

In summary, according to the method for processing sidelink consistent listen before talk failure provided by the embodiment of the present disclosure, the terminal device can, when it is determined that the sidelink consistent listen before talk (LBT) failure is triggered in the activated BWP or serving cell currently in use, cancel the consistent listen before talk failure status of the sidelink in the serving cell when the serving cell is deactivated, or the MAC CE containing the consistent LBT failure indication information of the consistent LBT failure in the serving cell is sent successfully, or the sidelink consistent LBT parameters associated with the serving cell are reconfigured, thereby ensuring the effective communication of the sidelink data in the serving cell in the unlicensed spectrum.

FIG. 5 shows a schematic flow chart of a method for processing sidelink consistent listen before talk failure according to an embodiment of the present disclosure. As shown in FIG. 5, the method is applied to a terminal device, and the embodiment may include the following steps.
Step 501: determine a reception of configuration information or reconfiguration information of mode conversion.

At present, there are two transmission resource allocation modes for sidelink communication: one is the mode of network dynamic scheduling (Mode 1); the other is the mode in which the terminal device autonomously selects resources from the network broadcast resource pool (Mode 2). The specific mode to be used can be configured by the network device through RRC signaling. In the disclosure, the network dynamic scheduling mode is that the network device dynamically allocates transmission resources on the sidelink to the terminal device based on the cached data reported by the terminal device. The resource autonomous selection mode is that the terminal device randomly selects transmission resources from the network broadcast or pre-configured resource pool.

For the embodiments of the present disclosure, as a possible implementation method, configuration information or reconfiguration information of mode conversion sent by the network side can be received, and the configuration information or reconfiguration information is used to configure the terminal device to perform the mode conversion configuration between the above-mentioned network dynamic scheduling mode (Mode 1) and the resource autonomous selection mode (Mode 2), such as reconfiguring from Model to Mode2 or reconfiguring from Mode2 to Model.
Step 502: the terminal device cancels all/any triggered sidelink consistent listen before talk failure state.

For the embodiment of the present disclosure, the terminal device cancels all/any triggered sidelink consistent listen before talk failure states, such as canceling the sidelink consistent LBT failure states associated with all unicast connections of the terminal device, and canceling the sidelink consistent LBT failure states of all associated broadcast and multicast services of the terminal device. This embodiment does not make specific limitations.

For the embodiments of the present disclosure, as a possible implementation method, if the mode of the terminal device is reconfigured from Mode2 to Model or from Model to Mode2, the terminal device cancels all/any triggered sidelink consistent LBT failure states. One possible implementation method is that the terminal device cancels the sidelink consistent LBT failure states of all associated resource pools and/or RB sets and/or BWPs. Association refers to all resource pools and/or RB sets and/or BWPs configured by the network side for the terminal device, or the resource pools and/or RB sets and/or BWPs used for resource selection and reselection when the terminal device operates in Mode 2, or the resource pools and/or RB sets and/or BWPs where resources scheduled by the network are located when the terminal device operates in Mode 1. This embodiment does not make specific limitations.

In summary, according to the method for processing the sidelink consistent listen before talk failure provided by the embodiment of the present disclosure, the terminal device can cancel all/any triggered sidelink consistent listen before talk failure states at the node when determining the reception of configuration information or reconfiguration information for mode conversion, thereby ensuring effective transmission of sidelink data on the unlicensed spectrum.

FIG. 6 shows a schematic flow chart of a method for processing sidelink consistent listen before talk failure according to an embodiment of the present disclosure. As shown in FIG. 6, the method is applied to a terminal device, and the embodiment may include the following steps.
Step 601: determine a reception of a high-layer request for resetting the media access control layer (MAC).

As a possible implementation, the media access control (MAC) layer of the terminal device receives a MAC reset request from a higher layer, and the terminal device cancels all/any triggered sidelink consistent listen before talk failure states. In practical applications, the higher layer may be a vehicle to everything (V2X) layer, etc.
Step 602: the terminal device cancels all/any triggered sidelink consistent listen before talk failure state.

For the embodiment of the present disclosure, the terminal device cancels all/any triggered sidelink consistent listen before talk failure states, such as canceling the sidelink consistent LBT failure states associated with all unicast connections of the terminal device, and canceling the sidelink consistent LBT failure states of all associated broadcast and multicast services of the terminal device. This embodiment does not make specific limitations.

For the embodiments of the present disclosure, as a possible implementation method, if the terminal device receives the MAC reset request, the terminal device cancels all/any triggered sidelink consistent LBT failure states. One possible implementation method is that the terminal device cancels the sidelink consistent LBT failure states of all associated resource pools and/or RB sets and/or BWPs. Association refers to all resource pools and/or RB sets and/or BWPs configured by the network side for the terminal device, or the resource pools and/or RB sets and/or BWPs used for resource selection and reselection when the terminal device operates in Mode 2, or the resource pools and/or RB sets and/or BWPs where resources scheduled by the network are located when the terminal device operates in Mode 1. This embodiment does not make specific limitations.

In summary, according to the sidelink consistent listen before talk failure processing method provided by the embodiment of the present disclosure, the terminal device can cancel all/any triggered sidelink consistent listen before talk failure states at a node when determining the reception of a MAC reset request, thereby ensuring the effective transmission of sidelink data on the unlicensed spectrum.

In the above embodiments provided by the present application, the method provided by the embodiment of the present application is introduced from the perspective of the terminal device. In order to implement the various functions in the method provided by the above embodiments of the present application, the terminal device may include a hardware structure and a software module, and implement the above functions in the form of a hardware structure, a software module, or a hardware structure plus a software module. A certain function of the above functions can be executed in the form of a hardware structure, a software module, or a hardware structure plus a software module.

Corresponding to the methods for processing the sidelink consistent listen before talk failure provided in the above-mentioned embodiments, the present application also provides an apparatus for processing the sidelink consistent listen before talk failure, which can be applied to the terminal device side. Since the apparatus for processing the sidelink consistent listen before talk failure provided in the embodiments of the present application corresponds to the method for processing the sidelink consistent listen before talk failure provided in the above-mentioned embodiments, the implementation methods of the method for processing the sidelink consistent listen before talk failure are also applicable to the apparatus for processing the sidelink consistent listen before talk failure provided in the present embodiment, which will not be described in detail in the present embodiment.

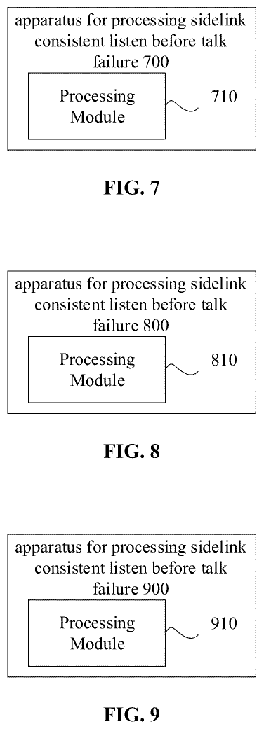

FIG. 7 is a schematic diagram of the structure of an apparatus for processing sidelink consistent listen before talk failure 700 provided by an embodiment of the present disclosure.

As shown in FIG. 7, the apparatus for processing sidelink consistent listen before talk failure 700 may include:
In some embodiments of the present disclosure, the processing module 710 may be used to determine a sidelink consistent listen before talk (LBT) failure being triggered in a unicast connection; and
The processing module 710 may also be used to cancel a state of sidelink consistent LBT failure of the unicast connection.

In some embodiments of the present disclosure, the processing module 710 may be specifically configured to determine reception of a high-layer request for resetting sidelink media access control of the unicast connection, and cancel the state of sidelink consistent LBT failure of the unicast connection.

In some embodiments of the present disclosure, the processing module 710 may be specifically configured to determine reception of a high-layer request for releasing the unicast connection, and cancel the state of sidelink consistent LBT failure of the unicast connection.

FIG. 8 is a schematic structural diagram of an apparatus for processing sidelink consistent listen before talk failure 800 provided by an embodiment of the present disclosure.

As shown in FIG. 8, the apparatus for processing sidelink consistent listen before talk failure 800 may include:
a processing module 810, may be used to determine a sidelink consistent listen before talk (LBT) failure being triggered in a resource pool; and
the processing module 810 may also be used to cancel a state of sidelink consistent LBT failure of the resource pool.

In some embodiments of the present disclosure, the processing module 810 may be specifically used to: a serving cell being deactivated, cancel the state of sidelink consistent LBT failure of all resource pool on an activated bandwidth BWP of the serving cell.

In some embodiments of the present disclosure, the processing module 810 can be specifically used to: a MAC CE including consistent LBT failure indication information indicating occurrence of the sidelink consistent LBT failure of the resource pool being transmitted successfully, cancel the state of sidelink consistent LBT failure of the resource pool.

In some embodiments of the present disclosure, the processing module 810 can be specifically used to determine sidelink consistent LBT parameter reconfiguration associated with a serving cell, and cancel the state of sidelink consistent LBT failure of all resource pool on the serving cell.

In some embodiments of the present disclosure, the processing module 810 can be specifically used to determine sidelink consistent LBT parameter reconfiguration associated with the resource pool, and cancel the state of sidelink consistent LBT failure of the resource pool.

In some embodiments of the present disclosure, the sidelink consistent LBT parameters include at least a maximum number of sidelink consistent LBT failures and a sidelink consistent LBT failure detection timer.

FIG. 9 is a schematic structural diagram of an apparatus for processing sidelink consistent listen before talk failure 900 provided by an embodiment of the present disclosure.

As shown in FIG. 9, the apparatus for processing sidelink consistent listen before talk failure 900 may include:
a processing module 910, which may be used to determine a sidelink consistent listen before talk (LBT) failure being triggered in a resource block set (RB set); and
the processing modules 910 may also be used to cancel a state of sidelink consistent LBT failure of the RB set.

In some embodiments of the present disclosure, the processing module 910 may be specifically used to: a serving cell being deactivated, cancel the state of sidelink consistent LBT failure of all RB sets on an activated bandwidth BWP of the serving cell.

In some embodiments of the present disclosure, the processing module 910 can be specifically used to: a MAC CE including consistent LBT failure indication information indicating occurrence of the sidelink consistent LBT failure of the RB set being transmitted successfully, cancel the state of sidelink consistent LBT failure of the RB set.

In some embodiments of the present disclosure, the processing module 910 can be specifically used to determine sidelink consistent LBT parameter reconfiguration associated with a serving cell, and cancel the state of sidelink consistent LBT failure of all resource pool on the RB set.

In some embodiments of the present disclosure, the processing module 910 can be specifically used to determine sidelink consistent LBT parameter reconfiguration associated with the RB set, and cancel the state of sidelink consistent LBT failure of the RB set.

In some embodiments of the present disclosure, the sidelink consistent LBT parameters include at least a maximum number of sidelink consistent LBT failures and a sidelink consistent LBT failure detection timer.

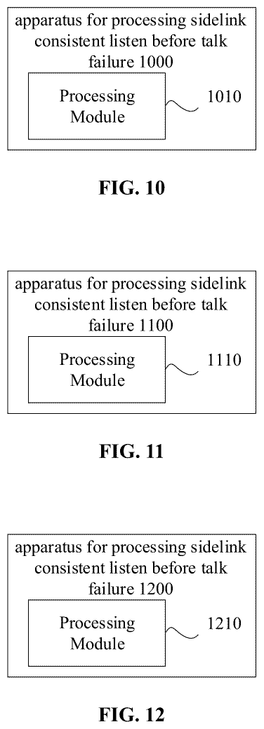

FIG. 10 is a schematic structural diagram of an apparatus for processing sidelink consistent listen before talk failure 1000 provided by an embodiment of the present disclosure.

As shown in FIG. 10, the apparatus for processing sidelink consistent listen before talk failure 1000 may include:
a processing module 1010, which may be configured to determine a sidelink consistent listen before talk (LBT) failure being triggered in a serving cell; and
the processing module 1010 may also be used to cancel a state of sidelink consistent LBT failure of the serving cell.

In some embodiments of the present disclosure, the processing module 1010 may be specifically used to deactivate the serving cell and cancel the state of sidelink consistent LBT failure of the serving cell.

In some embodiments of the present disclosure, the processing module 1010 may be specifically used to a MAC CE including consistent LBT failure indication information indicating occurrence of the sidelink consistent LBT failure of the serving cell being transmitted successfully, cancel the state of sidelink consistent LBT failure of the serving cell.

In some embodiments of the present disclosure, the processing module 1010 may be specifically configured to determine sidelink consistent LBT parameter reconfiguration associated with the serving cell, and cancel the state of sidelink consistent LBT failure of the serving cell.

In some embodiments of the present disclosure, the sidelink consistent LBT parameters include at least a maximum number of sidelink consistent LBT failures and a sidelink consistent LBT failure detection timer.

FIG. 11 is a schematic structural diagram of an apparatus for processing sidelink consistent listen before talk failure 1100 provided by an embodiment of the present disclosure.

FIG. 11, the apparatus for processing sidelink consistent listen before talk failure 1100 may include:
a processing module 1110, which may be used to determine a reception of reconfiguration information or configuration information of a mode conversion; and
the processing module 1110 may also be used by the terminal device to cancel all/any triggered state of sidelink consistent LBT failure.

In some embodiments of the present disclosure, the processing module 1110 may be specifically configured for the terminal device to cancel the state of sidelink consistent LBT failure of all associated resource pool and/or RB set and/or BWP.

In some embodiments of the present disclosure, the associated resource pool and/or RB set and/or BWP includes at least one of:
all resource pool and/or RB set and/or BWP configured by a network side for the terminal device;
the resource pool and/or RB set and/or BWP used for resource selection and reselection when the terminal device is operated in a resource autonomous selection mode; or
the resource pool and/or RB set and/or BWP on which a resource scheduled by the network device is located when the terminal device is operated in a network dynamic scheduling mode.

FIG. 12 is a schematic structural diagram of an apparatus for processing sidelink consistent listen before talk failure 1200 provided by an embodiment of the present disclosure.

As shown in FIG. 12, the apparatus for processing sidelink consistent listen before talk failure 1200 may include:
a processing module 1210, which may be used to determine a reception of a higher-layer request for a media access control layer (MAC) reset; and
the processing module 1210 may also be used for the terminal device to cancel all/any triggered state of sidelink consistent LBT failure.

In some embodiments of the present disclosure, the processing module 1210 may be specifically configured for the terminal device to cancel the state of sidelink consistent LBT failure of all associated resource pool and/or RB set and/or BWP.

In some embodiments of the present disclosure, the associated resource pool and/or RB Set and/or BWP includes at least one of:
all resource pool and/or RB set and/or BWP configured by a network side for the terminal device;
the resource pool and/or RB set and/or BWP used for resource selection and reselection when the terminal device is operated in a resource autonomous selection mode; or
the resource pool and/or RB set and/or BWP on which a resource scheduled by the network device is located when the terminal device is operated in a network dynamic scheduling mode.

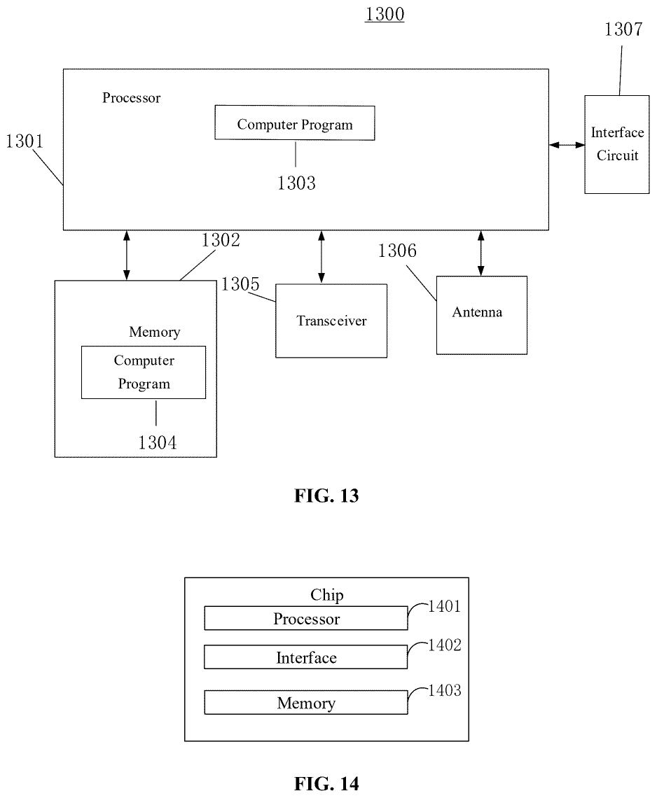

Please refer to FIG. 13, which is a schematic diagram of the structure of a communication device 1300 provided in an embodiment of the present application. The communication device 1300 can be a network device, or a user device, or a chip, a chip system, or a processor that supports the network device to implement the above method, or a chip, a chip system, or a processor that supports the user device to implement the above method. The device can be used to implement the method described in the above method embodiment, and the details can be referred to the description in the above method embodiment.

The communication device 1300 may include one or more processors 1301. The processor 1301 may be a general-purpose processor or a dedicated processor, etc. For example, it may be a baseband processor or a central processing unit. The baseband processor may be used to process the communication protocol and communication data, and the central processing unit may be used to control the communication device (such as a base station, a baseband chip, a terminal device, a terminal device chip, a DU or a CU, etc.), execute a computer program, and process the data of the computer program.

Optionally, the communication device 1300 may further include one or more memories 1302, on which a computer program 1304 may be stored, and the processor 1301 executes the computer program 1304, so that the communication device 1300 performs the method described in the above method embodiment. Optionally, data may also be stored in the memory 1302. The communication device 1300 and the memory 1302 may be provided separately or integrated together.

Optionally, the communication device 1300 may further include a transceiver 1305 and an antenna 1306. The transceiver 1305 may be referred to as a transceiver unit, a transceiver, or a transceiver circuit, etc., for implementing a transceiver function. The transceiver 1305 may include a receiver and a transmitter, the receiver may be referred to as a receiver or a receiving circuit, etc., for implementing a receiving function; the transmitter may be referred to as a transmitter or a transmitting circuit, etc., for implementing a transmitting function.

Optionally, the communication device 1300 may further include one or more interface circuits 1307. The interface circuit 1307 is used to receive code instructions and transmit them to the processor 1301. The processor 1301 runs the code instructions to enable the communication device 1300 to execute the method described in the above method embodiment.

In one implementation, the processor 1301 may include a transceiver for implementing the receiving and sending functions. For example, the transceiver may be a transceiver circuit, an interface, or an interface circuit. The transceiver circuit, interface, or interface circuit for implementing the receiving and transmitting functions may be separate or integrated. The above-mentioned transceiver circuit, interface, or interface circuit may be used for reading and writing code/data, or the above-mentioned transceiver circuit, interface, or interface circuit may be used for transmitting or delivering signals.

In one implementation, the processor 1301 may store a computer program 1303, and the computer program 1303 runs on the processor 1301, so that the communication device 1300 can execute the method described in the above method embodiment. The computer program 1303 may be fixed in the processor 1301, in which case, the processor 1301 may be implemented by hardware.

In one implementation, the communication device 1300 may include a circuit that can implement the functions of sending or receiving or communicating in the aforementioned method embodiment. The processor and transceiver described in the present application can be implemented in an integrated circuit (IC), an analog IC, a radio frequency integrated circuit RFIC, a mixed signal IC, an application specific integrated circuit (ASIC), a printed circuit board (PCB), an electronic device, etc. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), etc.

The communication device described in the above embodiments may be a network device or a user device, but the scope of the communication device described in the present application is not limited thereto, and the structure of the communication device may not be limited by FIG. 13. The communication device may be an independent device or may be part of a larger device. For example, the communication device may be:
(1) Independent integrated circuit IC, or chip, or chip system or subsystem;
(2) A set of one or more ICs, optionally including a storage component for storing data or computer programs;
(3) Asic, such as modem;
(4) Modules that can be embedded in other devices;
(5) Receivers, terminal devices, intelligent terminal devices, cellular phones, wireless devices, handheld devices, mobile units, vehicle-mounted devices, network devices, cloud devices, artificial intelligence devices, etc.; and
(6) Others.

For the case where the communication device can be a chip or a chip system, please refer to the schematic diagram of the chip structure shown in FIG. 14. The chip shown in FIG. 14 includes a processor 1401 and an interface 1402. The number of processors 1401 can be one or more, and the number of interfaces 1402 can be multiple.

Optionally, the chip further includes a memory 1403, and the memory 1403 is used to store necessary computer programs and data.

Those skilled in the art may also understand that the various illustrative logical blocks and steps listed in the embodiments of the present application may be implemented by electronic hardware, computer software, or a combination of the two. Whether such functions are implemented by hardware or software depends on the specific application and the design requirements of the entire system. Those skilled in the art may use various methods to implement the functions for each specific application, but such implementation should not be understood as exceeding the scope of protection of the embodiments of the present application.

The present application also provides a readable storage medium having instructions stored thereon, which implement the functions of any of the above method embodiments when executed by a computer.

The present application also provides a computer program product, which implements the functions of any of the above method embodiments when executed by a computer.

In the above embodiments, it can be implemented in whole or in part by software, hardware, firmware or any combination thereof. When implemented using software, it can be implemented in whole or in part in the form of a computer program product. The computer program product includes one or more computer programs. When the computer program is loaded and executed on a computer, the process or function according to the embodiment of the present application is generated in whole or in part. The computer can be a general-purpose computer, a special-purpose computer, a computer network, or other programmable device. The computer program can be stored in a computer-readable storage medium, or transmitted from one computer-readable storage medium to another computer-readable storage medium. For example, the computer program can be transmitted from a website site, computer, server or data center by wired (e.g., coaxial cable, optical fiber, digital subscriber line (DSL)) or wireless (e.g., infrared, wireless, microwave, etc.) means to another website site, computer, server or data center. The computer-readable storage medium can be any available medium that can be accessed by a computer or a data storage device such as a server or data center that contains one or more available media integrated. The available media may be magnetic media (e.g., floppy disk, hard disk, tape), optical media (e.g., digital video disc (DVD)), or semiconductor media (e.g., solid state disk (SSD)), etc.

The present disclosure proposes a method for processing the sidelink consistent listen before talk failure, which can solve the problem in the Sidelink-U scenario that when the sidelink consistent listen before talk failure is triggered, the terminal device is unclear about when to cancel the consistent LBT failure state.

Based on the present disclosure, an example of a specific implementation is as follows:
For a unicast connection (such as PC5-RRC), the upper layer requests the SL MAC reset, and the UE cancels the SL consistent LBT failure state associated with this PC5-RRC connection.

As an optional embodiment, the consistent LBT failure detection granularity is the source address and target address pair granularity. When the MAC layer receives a SL MAC reset request from the higher layer for a PC5-RRC connection, the UE cancels the SL consistent LBT failure status associated with the PC5-RRC connection.

For a PC5-RRC connection, the higher layer requests to release the PC5-RRC connection, and the UE cancels the SL consistent LBT failure state associated with the PC5-RRC connection.

As an optional embodiment, the consistent LBT failure detection granularity is the source address and target address pair granularity. When the higher layer requests to release the PC5-RRC connection, the UE cancels the SL consistent LBT failure state associated with the PC5-RRC connection.

The serving cell being deactivated, the UE cancels the SL consistent LBT failure status of all resource pools/RB sets on this serving cell.

As an optional embodiment, the consistent LBT failure detection granularity is the resource pool granularity. When the serving cell is deactivated, the SL consistent LBT failure status of all resource pools on the activated BWP (bandwidth) of the serving cell is cancelled.

As an optional embodiment, the consistent LBT failure detection granularity is the RB set granularity. When the serving cell is deactivated, the SL consistent LBT failure status of all RB sets on all resource pools on the activated BWP of the serving cell is cancelled.

The serving cell being deactivated, the UE cancels the SL consistent LBT failure status of this serving cell.

As an optional embodiment, the consistent LBT failure detection granularity is the BWP granularity or the cell granularity, and when the serving cell is deactivated, the SL consistent LBT failure state of the serving cell is canceled.

The SL consistent LBT failure MAC CE containing the consistent LBT failure indication of the resource pool/RB set/BWP/cell where the SL consistent LBT failure occurred being sent successfully, the SL consistent LBT failure status of this resource pool/RB set/BWP/cell is cancelled.

As an optional embodiment, the consistent LBT failure detection granularity is the resource pool granularity, the MAC PDU including the SL consistent LBT failure MAC CE being sent successfully (LBT succeeds without receiving the LBT failure indication submitted by the physical layer), and this SL consistent LBT failure MAC CE including the SL consistent LBT failure indication of this resource pool, cancel the SL consistent LBT failure status of this resource pool.

As an optional embodiment, the consistent LBT failure detection granularity is the RB set granularity, the MAC PDU including the SL consistent LBT failure MAC CE being sent successfully (LBT succeeds without receiving the LBT failure indication submitted by the physical layer), and the SL consistent LBT failure MAC CE including the SL consistent LBT failure indication of this RB set, cancel the SL consistent LBT failure status of this RB set.

As an optional embodiment, the consistent LBT failure detection granularity is the BWP/cell granularity, the MAC PDU including the SL consistent LBT failure MAC CE being sent successfully (LBT succeeds without receiving the LBT failure indication submitted by the physical layer), and this SL consistent LBT failure MAC CE including the SL consistent LBT failure indication of this BWP/cell, cancel the SL consistent LBT failure status of this BWP/cell.

SL consistent LBT parameters being reconfigured, the UE cancels the SL consistent LBT failure status of all resource pools/RB sets on the serving cell.

As an optional embodiment, the SL consistent LBT parameters include configuration parameters such as the maximum number of consistent LBT failures and a consistent LBT failure detection timer. If the SL consistent LBT parameters are configured per serving cell, and the SL consistent LBT failure detection granularity is the resource pool granularity, when the SL consistent LBT parameters are reconfigured, the SL consistent LBT failure status of all resource pools on the reconfigured serving cell is canceled.

As an optional embodiment, the SL consistent LBT parameters include configuration parameters such as the maximum number of consistent LBT failures and a consistent LBT failure detection timer. If the SL consistent LBT parameters are configured per serving cell, and the SL consistent LBT failure detection granularity is the RB set granularity, when the SL consistent LBT parameters are reconfigured, the SL consistent LBT failure status of all RB sets on all resource pools on the reconfigured serving cell is canceled.

The SL consistent LBT parameters being reconfigured, the UE cancels the SL consistent LBT failure status of the serving cell.

As an optional embodiment, the SL consistent LBT parameters include configuration parameters such as the maximum number of consistent LBT failures and the consistent LBT failure detection timer. If the SL consistent LBT parameters are configured per serving cell, and the SL consistent LBT detection granularity is BWP/cell granularity, when the SL consistent LBT parameters are reconfigured, the SL consistent LBT failure status of the reconfigured serving cell is canceled.

The SL consistent LBT parameters being reconfigured, the UE cancels the SL consistent LBT failure status of the reconfigured resource pool.

As an optional embodiment, the SL consistent LBT parameters include configuration parameters such as the maximum number of consistent LBT failures and the consistent LBT failure detection timer. If the SL consistent LBT parameters are configured per resource pool, and the SL consistent LBT detection granularity is the resource pool granularity, when the SL consistent LBT parameters are reconfigured, the SL consistent LBT failure status of the reconfigured resource pool is canceled.

The SL consistent LBT parameters being reconfigured, the UE cancels the SL consistent LBT failure status of the reconfigured RB set.

As an optional embodiment, the SL consistent LBT parameters include configuration parameters such as the maximum number of consistent LBT failures and the consistent LBT failure detection timer. If the SL consistent LBT parameters are configured per RB set, and the SL consistent LBT detection granularity is the RB set granularity, when the SL consistent LBT parameters are reconfigured, the SL consistent LBT failure status of the reconfigured RB set is canceled.

In summary, the present disclosure has the following beneficial technical effects:
the present disclosure proposes a method for processing the failure of sidelink consistent listen before talk, the terminal device can support cancelling the state of sidelink consistent LBT failure, when determining the sidelink consistentLBT failure being triggered under different detection granularities in a Sidelink-U scenario (such as source address and destination address pair granularity, resource pool granularity, BWP granularity or cell granularity, resource block set (RB set), etc.).

A person skilled in the art may understand that the various numerical numbers such as first and second involved in the present application are only used for the convenience of description and are not used to limit the scope of the embodiments of the present application, and also indicate the order of precedence.

At least one in the present application can also be described as one or more, and a plurality can be two, three, four or more, which is not limited in the present application. In the embodiments of the present application, for a technical feature, the technical features in the technical feature are distinguished by “first,” “second,” “third,” “A,” “B,” “C” and “D,” etc., and there is no order of precedence or size between the technical features described by the “first,” “second,” “third,” “A,” “B,” “C” and “D”.

As used herein, the terms “machine-readable medium” and “computer-readable medium” refer to any computer program product, apparatus, and/or device (e.g., disk, optical disk, memory, programmable logic device (PLD)) for providing machine instructions and/or data to a programmable processor, including a machine-readable medium that receives machine instructions as a machine-readable signal. The term “machine-readable signal” refers to any signal for providing machine instructions and/or data to a programmable processor.

The systems and techniques described herein may be implemented in a computing system that includes back-end components (e.g., as a data server), or a computing system that includes middleware components (e.g., an application server), or a computing system that includes front-end components (e.g., a user computer with a graphical user interface or a web browser through which a user can interact with implementations of the systems and techniques described herein), or a computing system that includes any combination of such back-end components, middleware components, or front-end components. The components of the system may be interconnected by any form or medium of digital data communication (e.g., a communication network). Examples of communication networks include: a local area network (LAN), a wide area network (WAN), and the Internet.

A computer system may include clients and servers. Clients and servers are generally remote from each other and usually interact through a communication network. The relationship of client and server is generated by computer programs running on respective computers and having a client-server relationship to each other.

It should be understood that the various forms of processes shown above can be used, with reordered, added or deleted steps. For example, the steps described in this disclosure can be executed in parallel, sequentially or in different orders, as long as the desired results of the technical solutions disclosed in this disclosure can be achieved, and this document does not limit this.

In addition, it should be understood that the various embodiments of the present application may be implemented individually or in combination with other embodiments when the solution permits.

Those of ordinary skill in the art will appreciate that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Those skilled personnel can use different methods to implement the described functions for each specific application, but such implementation should not be considered to be beyond the scope of this application.

Those skilled in the art can clearly understand that, for the convenience and brevity of description, the specific operating processes of the systems, devices and units described above can refer to the corresponding processes in the aforementioned method embodiments and will not be repeated here.

The above are only specific implementations of the present application, but the protection scope of the present application is not limited thereto. Any changes or substitutions easily conceivable to the skilled person familiar with the technical field within the technical scope disclosed in the present application should be included in the protection scope of the present application. Therefore, the protection scope of the present application should be based on the protection scope of the claims.

1. A method for processing sidelink consistent listen before talk (LBT) failure, executed by a terminal device, the method comprising:
determining a sidelink consistent listen before talk (LBT) failure being triggered in a unicast connection; and
cancelling a state of sidelink consistent LBT failure of the unicast connection.

2. The method according to claim 1, wherein the cancelling the state of sidelink consistent LBT failure of the unicast connection comprises:
determining reception of a high-layer request for resetting sidelink media access control of the unicast connection, and cancelling the state of sidelink consistent LBT failure of the unicast connection.

3. The method according to claim 1, wherein the cancelling the state of sidelink consistent LBT failure of the unicast connection comprises:
determining reception of a high-layer request for releasing the unicast connection, and cancelling the state of sidelink consistent LBT failure of the unicast connection.

4. A method for processing sidelink consistent listen before talk (LBT) failure, executed by a terminal device, the method comprising:
determining a sidelink consistent listen before talk (LBT) failure being triggered in a resource pool or a resource block set (RB set) or a serving cell; and
cancelling a state of sidelink consistent LBT failure of the resource pool or the RB set or the serving cell.

5. The method according to claim 4, wherein the cancelling the state of sidelink consistent LBT failure of the resource pool or the RB set comprises:
the serving cell being deactivated, and cancelling the state of sidelink consistent LBT failure of all resource pool or the RB set on an activated bandwidth part (BWP) of the serving cell.

6. The method according to claim 4, wherein the cancelling the state of sidelink consistent LBT failure of the resource pool or the RB set or the serving cell comprises:
a MAC CE comprising consistent LBT failure indication information indicating occurrence of the sidelink consistent LBT failure of the resource pool or the RB set or the serving cell being transmitted successfully, and cancelling the state of sidelink consistent LBT failure of the resource pool or the RB set or the serving cell.

7. The method according to claim 4, wherein the cancelling the state of sidelink consistent LBT failure of the resource pool or the RB set comprises:
determining sidelink consistent LBT parameter reconfiguration associated with a the serving cell, and cancelling the state of sidelink consistent LBT failure of all resource pool or the RB set on the serving cell.

8. The method according to claim 4, wherein the cancelling the state of sidelink consistent LBT failure of the resource pool or the RB set comprises:
determining sidelink consistent LBT parameter reconfiguration associated with the resource pool or the RB set, and cancelling the state of sidelink consistent LBT failure of the resource pool or the RB set.

9. The method according to claim 7, wherein the sidelink consistent LBT parameter at least comprises a maximum number of the sidelink consistent LBT failure and a detection timer of the sidelink consistent LBT failure.

10-16. (canceled)

17. The method according to claim 4, wherein the cancelling the state of sidelink consistent LBT failure of the serving cell comprises:
the serving cell being deactivated, and cancelling the state of sidelink consistent LBT failure of the serving cell.

18. (canceled)

19. The method according to claim 4, wherein the cancelling the state of sidelink consistent LBT failure of the serving cell comprises:
determining sidelink consistent LBT parameter reconfiguration associated with the serving cell, and cancelling the state of sidelink consistent LBT failure of the serving cell.

20. (canceled)

21. A method for processing sidelink consistent listen before talk (LBT) failure, executed by a terminal device, the method comprising:
determining a reception of reconfiguration information or configuration information of a mode conversion or a reception of higher-layer request for a media access control layer (MAC) reset; and
cancelling, by the terminal device, all/any triggered state of sidelink consistent LBT failure.

22. The method according to claim 21, wherein the cancelling, by the terminal device, all/any triggered state of sidelink consistent LBT failure comprises:
cancelling, by the terminal device, the state of sidelink consistent LBT failure of all associated resource pool and/or RB set and/or BWP.

23. The method according to claim 22, wherein the associated resource pool and/or RB set and/or BWP comprises at least one of:
all resource pool and/or RB set and/or BWP configured by a network device for the terminal device;
the resource pool and/or RB set and/or BWP used for resource selection and reselection when the terminal device is operated in a resource autonomous selection mode; or
the resource pool and/or RB set and/or BWP on which a resource scheduled by the network device is located when the terminal device is operated in a network dynamic scheduling mode.

24-32. (canceled)

33. A communication device, comprising:
a transceiver;
a memory that stores computer executable instructions; and
a processor, connected to the transceiver and the memory respectively,
wherein the computer executable instructions when executed by the processor, cause the communication device to act as the terminal device and perform the method according to claim 1.

34. A non-transient computer storage medium, wherein the computer storage medium stores computer executable instructions; the computer executable instructions when executed by a processor of the terminal device, cause the terminal device to perform the method according to claim 1.

35. A communication device, comprising:
a transceiver;
a memory that stores computer executable instructions; and
a processor, connected to the transceiver and the memory respectively,
wherein the computer executable instructions when executed by the processor, cause the communication device to act as the terminal device and perform the method according to claim 4.

36. A non-transient computer storage medium, wherein the computer storage medium stores computer executable instructions; the computer executable instructions when executed by a processor of the terminal device, cause the terminal device to perform the method according to claim 4.

37. A communication device, comprising:
a transceiver;
a memory that stores computer executable instructions; and
a processor, connected to the transceiver and the memory respectively,
wherein the computer executable instructions when executed by the processor cause the communication device to act as the terminal device and perform the method according to claim 21.

38. A non-transient computer storage medium, wherein the computer storage medium stores computer executable instructions; the computer executable instructions when executed by a processor of the terminal device, cause the terminal device to perform the method according to claim 21.
